(19) United States
(12) Patent Application Publication
(10) Pub. No.: US 2022/0205584 A1
(43) Pub. Date: Jun. 30, 2022

(54) Travel tripod

(71) Applicant: Bo Christensen, Nordberg (DK)

(72) Inventor: Bo Christensen, Nordberg (DK)

(73) Assignee: Savage Universal Inc.

(21) Appl. No.: 16/974,320

(22) Filed: Dec. 28, 2020

(51) Int. Cl. F16M 11/32

(52) U.S. Cl. CPC F16M 11/32; G03B 17/561; F16M 2200/08

(57) ABSTRACT

A tripod having a first side leg, a second side leg, and a hollow leg. The three legs are connected to a center member which use swivels for the first side leg and the second side leg. The hollow leg engages a hollow circular receiver which allows an extension member to extend from the interior of the hollow leg, through center member. An attachment mechanism, such as for a camera, is secured to the distal end of the extension. The attachment mechanism permits the camera secured thereto to be rotated and directed to the operator's desires.

### PRIORITY

Priority for this application is claimed from Provisional Patent applications Ser. No. 62/995,491, filed on Jan. 30, 2020, and entitled “Travel Tripod”.

### BACKGROUND OF THE INVENTION

This invention relates generally to photographic equipment and more particularly to tripods used in the field and in studios.

Tripods have been used for decades to hold a camera or a telescope steady during use. In very general terms, the tripod has three legs which converge onto a central platform. By adjusting the length of the three legs, the height and slope of the platform may be defined. Although early tripods had the camera secured directly to the platform, more recent developments utilize a center column or extension extending from the platform on which the camera is secured.

If the sought after “view” for the camera is close to the ground, such as a photograph of a flower, the tripod is adjusted with the center column being removed and placed to extend from the bottom of the platform.

This movement of the center column is time consuming to setup.

Adjustment of the height of the platform is also difficult since this adjustment requires the extension of three legs in unison. This is both difficult and very awkward.

Since traditional tripods have their leg arrangements forming a “circle” around the center column. When the legs are “collapsed” against each other for transportation, the result is bulky. To compensate, the traditional tripod uses smaller diameter for the legs.

In obtaining a top view downward, the traditional tripod, even with the extension from the legs must be poised encircling the object which is all too often impossible if the object is near a wall, a river, or other such barrier.

It is clear there are many limitations for the traditional tripod and there is a significant need for a more versatile and easy to use portable tripod.

### SUMMARY OF THE INVENTION

The invention is an improved tripod which is easier to use and more versatile than the existing art. In the invention, the tripod has a first side leg, a second side leg, and a hollow third leg. The three legs are connected to a center member which acts as a platform and hinges for the legs. The center member uses swivels for the first side leg and the second side leg.

The hollow leg engages a hollow circular receiver on the center member and allows an extension member to extend from the interior of the hollow leg, through the center member. This extension is “locked” to the desired length by the operator. An attachment mechanism, such as for a camera, is secured to the distal end of the extension. The attachment mechanism permits the camera secured thereto to be rotated and directed to the operator's desires.

More specifically, this unique tripod allows the center column to extend from the inside of the middle leg instead of being positioned at the center of three encircling legs as found in the prior art. This permits the entire structure to stand in a “splayed” relationship. That is the first and second legs are positioned as would be found in a traditional tripod, but, the third leg is extendable from the center platform at another angle.

The third leg (hollow) is able to moved in a single plane as defined by the receiver; the other two legs are given much more freedom of movement by their associated swivel connections.

This arrangement provides a faster and more convenient way when switching between upright and low-to-ground shots. The extension's mounting mechanism, attached to the distal end of the extension permits the camera to be rotated around the center line of the extension by simply rotating the extension itself. This arrangement eliminates the prior art's dismantling and reassembly to configure low-to-ground pictures/shots.

Unlike the prior art where the three legs are positioned in a symmetrical pattern around the platform, the present invention places the third hollow leg's receiver substantially between the other two swivels. This generates a more compact arrangement permitting the use of thicker legs while still keeping a compact transportation size.

The lengths of the three legs are extendable/collapsible allowing the tripod to be easily transported. While the preferred embodiment for locking the legs at a desired length is through the use of cinching nut mechanisms, those of ordinary skill in the art readily recognize a variety of other techniques which can be used in this context, including, but not limited to those described in: U.S. Pat. No. 10,508,765, entitled “Extendible Tripod Leg” issued to Torbitt, et al. on Dec. 17, 2019; and U.S. Pat. No. 10,760,729, entitled “Tripod” issued to Balmer on Sep. 1, 2020; both of which are incorporated hereinto by reference.

Because the legs are not positioned in a “circle” as the prior art, they fold easier against each other and allows the legs to be thicker than the prior art. The thicker legs provide more stability with thicker legs and just two hinged points (instead of three on traditional tripods).

The tripod packs more compact than traditional tripods due to the legs being more in a line with each other.

As noted, the tripod of this invention places the center column/extension on the inside of the main or hollow leg instead of in the middle of the platform with the three encircling legs of the prior art's use of the platform. This frees up more space for the legs to be thicker while still staying compact when folded for transportation and allows the camera, via the estension, to be at a more convenient location away from the tripod legs.

In one embodiment of the invention, the extension is removable allowing for the use of varying length extensions for a particular application.

In another embodiment of the invention, the hollow leg, unlike the prior art, has the leg thicker at the bottom than at the top. When this leg is collapsed, the hollow inner portion is not disturbed by the collapsing leg, thereby allowing the extension to remain within the hollow leg even when collapsed.

In practice, the user stands between the two legs and operates the tripod therefrom. The center leg and column would be pointing “towards” the subject. The center offset camera, extending from the hollow third leg, allows the user to be closer to the camera to operating the camera without the legs being in the way. For upward shots, the “overhang” of the camera enables a more convenient position for a user to get underneath the camera doing upward directed shots.

Further advantages of this invention's arrangements are that:
1) More stability due to only two hinge points instead of three as on a traditional tripod. This means less articulation around the hinged legs;
2) The ability to switch from upright to close to the ground shots very fast. No need for the center column to be removed or reconfigured. One simply has to angle the two side legs at a more spread angle'
3) The switching of the camera to get ultra-close to the ground shots (hanging it upside-down) is simply done by rotating the extension; and,
4) The increased stability of offset camera due to the narrower angle between the legs allow the angle of legs to be narrowed when close to the ground.

The uniquely angled leg hinges position all three legs at 120 degree intervals when the tripod is in its upright configuration, but, at narrower angles when they are folded outwards. This means more stability for the offset camera.

Because of the invention's leg arrangement, to create a horizontal setup, the user simply lowers the two side legs and extends the center column. To do a direct downward shot, the user turns the ball head. For additional height, the user extends the side legs.

Another major advantage of the leg arrangement of this invention is that the invention's tripod is also useful as a monopod due to the center hollow column and head being placed directly in line and is therefore balanced directly over the center leg. This monopod arrangement for the prior art is awkward and unbalanced with traditional tripods since the head and center column are placed offset from the three legs. The weight being centered directly over the leg in this invention is ideal.

One embodiment of the invention features a fold away hook on the main platform. The hook is used to hang stabilizing weight such as a backpack. The hook is positioned to allow a backpack to hand unobstructed between the two side legs meaning a user has easy access to the bag's contents.

Ideally, the center platform employs the use of wide shoulders to minimize the torque that might occur doing video panning. No torque/twisting of the hinge while panning the camera.

In another embodiment, the front of the center hinge features a ⅜ inch tapped attachment point for peripheral accessories such an articulating arm with monitor.

A recessed area between the two side legs allows the head to be lowered more compactly for transportation.

Due to the extra space gained by not having the separate center column and by having the legs more in line with each other, the diameter of each legs has been increased to give more stability. That is the first section center leg has a diameter of 46 mm whereas the traditional tripod legs are around 32 mm.

The tripod packs more compact than traditional tripods due to the legs being more in line with each other and the head tucked in position.

The invention, together with various embodiments thereof will be more fully explained by the accompanying drawings and the following description thereof.

### DRAWINGS IN BRIEF

FIG. 1 illustrates the preferred embodiment of the invention.

FIGS. 2A and 2B illustrate a side and frontal view of the invention holding a camera.

FIGS. 3A and 3B illustrates the relative positions of the legs of the invention as compared to the prior art (FIG. 3B).

FIG. 4 illustrates the positions of the legs together with the extension member.

FIGS. 5A and 5B illustrates the tripod positioned for a close to ground shot.

FIG. 6 illustrates an embodiment of the center hollow leg that maintains the hollow nature when collapsed

FIG. 7 illustrates the tripod of this invention being used as monopod.

FIG. 8 illustrates the legs and platform of the preferred embodiment.

FIG. 9 illustrates the tripod collapsed for transportation.

FIG. 10 illustrates the deployment of a screen from the platform.

### DRAWINGS IN DETAIL

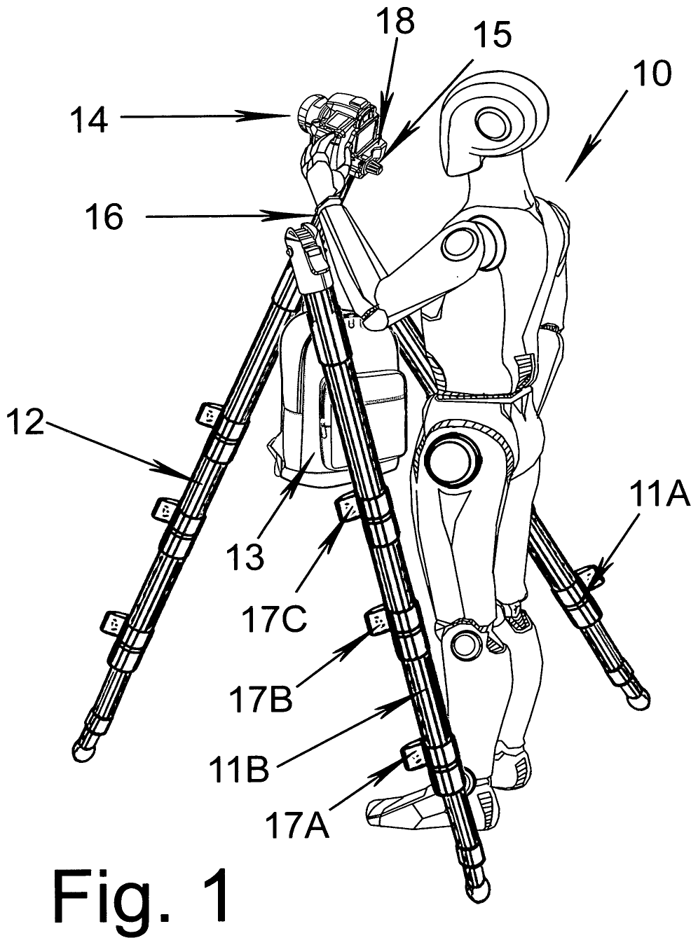

FIG. 1 illustrates the preferred embodiment of the invention.

A user 10 operates the tripod from between the two side legs 11A and 11B. The hollow center leg 12 and column/extension 16 be pointing towards the subject. The two side legs 11A and 11B and hollow center leg 12 are connected to a center member 16. The center member 16 uses swivels for the first side leg and the second side leg allowing a great deal of freedom of movement.

The hollow center leg 12 engages a circular receiver (not visible in this illustration) on the center member 16 and allows an extension member 15 to extend from the interior of the hollow center leg 12, through the center member 15. An attachment mechanism 18, such as for a camera 14, is secured to the distal end of the extension member 15. The attachment mechanism 18 permits the camera secured thereto to be rotated and directed to the operator's desires.

This arrangement permits the entire structure to stand in a “splayed” relationship. That is the first and second legs 11A and 11B are positioned as would be found in a traditional tripod, but, the third leg, the hollow center leg 12, is extendable from the center platform at another angle.

A hook (not visible) is positioned below the platform 16 and allows a backpack 13 to hang unobstructed between the two side legs 11A and 11B. In this manner, user 10 has easy access to the bag's 13 contents.

The lengths of the two legs 11A and 11B, as well as the hollow center leg 12, are extendable/collapsible allowing the tripod to be easily transported. The preferred embodiment locks through the use of cinching nut mechanisms (17A, 17B, and 17C). These cinching nut mechanisms are tightened or loosen using the user's fingers.

In one embodiment of the invention, the hollow center leg 12, is “opposite” of a traditional leg in that the bottom section is wider than the section above it, allowing the bottom section to “slide” over the upper section. This frees up the center of the hollow center leg during transportation so that the extension 15 may remain within the leg.

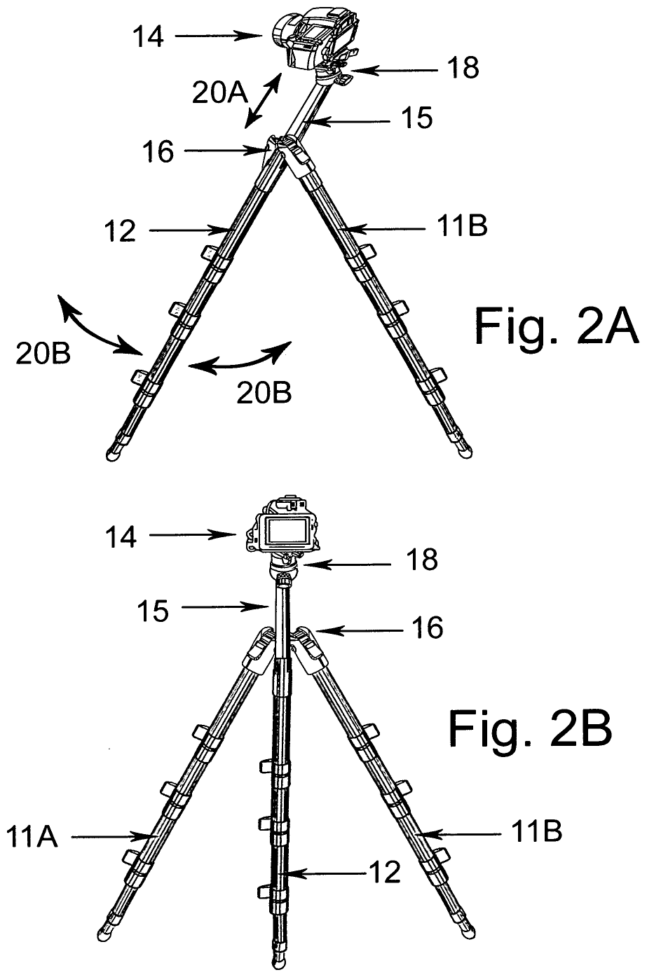

FIGS. 2A and 2B illustrate a side and frontal view of the invention holding a camera.

To deploy the tripod, the two side legs 11A and 11B are extended the center hollow leg 12 is also extended. Note in FIG. 2A, the hollow center leg 12 is extended into a “splay” type of arrangement relative to legs 11A and 11B. Movement of hollow center leg 12 occurs as indicated by arrows 20B.

The center offset of camera 14, now extending between legs 11A and 11B, allows the user to be closer to operating the camera 14 without the legs 11A, 11B, nor hollow center leg 12 being in the way.

Hollow center leg is secured to center member 16 in such a manner that extension 15 is allowed to slide within hollow center leg 12.

At the top of the hollow center leg 15, is extension 15 which is moveable within the hollow center leg 12 as indicated by arrow 20A. This movement allows the camera 14, secured to attachment 18, to be moved to the height desired by the user or “spun” into a desired orientation.

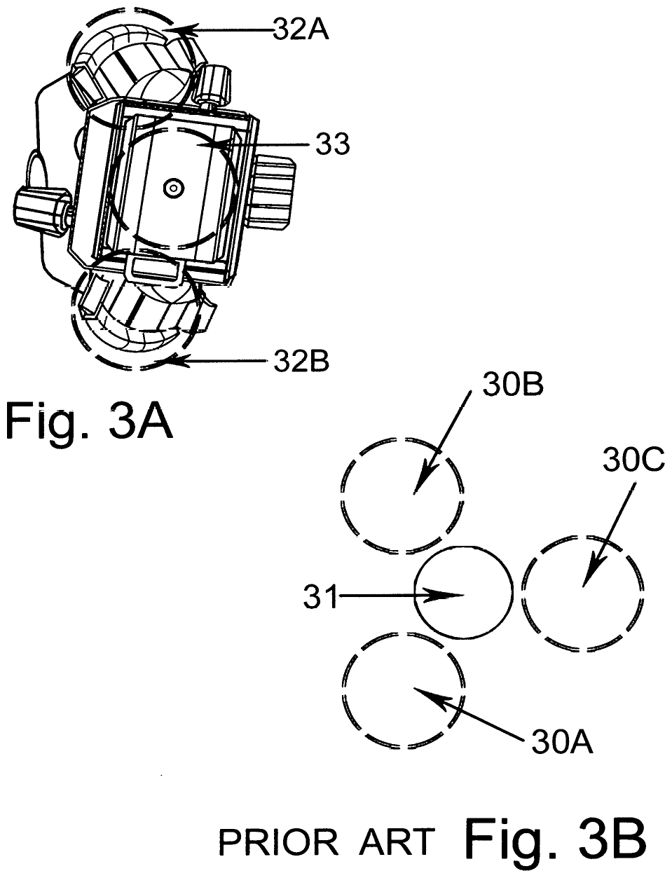

FIGS. 3A and 3B illustrates the relative positions of the legs of the invention as compared to the prior art (FIG. 3B).

Referencing FIG. 3B, the prior art, the legs are all positioned equal distance (120 degrees) for each other, 30A, 30B, and 30C. The extension 31 is positioned between the three leg swivels/hinges.

As shown in FIG. 3A, the present invention positions the two legs 32A and 32B having the extension (provided by the hollow third leg) 33 substantially in line or substantially between the other two swivels. This generates a more compact arrangement permitting the use of thicker legs while still keeping a compact transportation size.

Further, since there are only two hinge points (32A an 32B), instead of three for the prior art, the twisting potential is minimized which creates a more stable platform. This arrangement also provides for a wider distance between the hinges 32A and 32B which avoids the “twisting” potential of the prior art when doing a video panning (movement of the camera).

The tripod of FIG. 3A has the center column extending from the inside of the center hollow leg instead of in the middle of three encircling legs. This frees up more space for the legs of the present invention (FIG. 3A) to be thicker while still staying compact when folded for transportation. In the preferred embodiment, the leg diameters are 46 mm whereas the traditional tripod legs are approximately 32 mm.

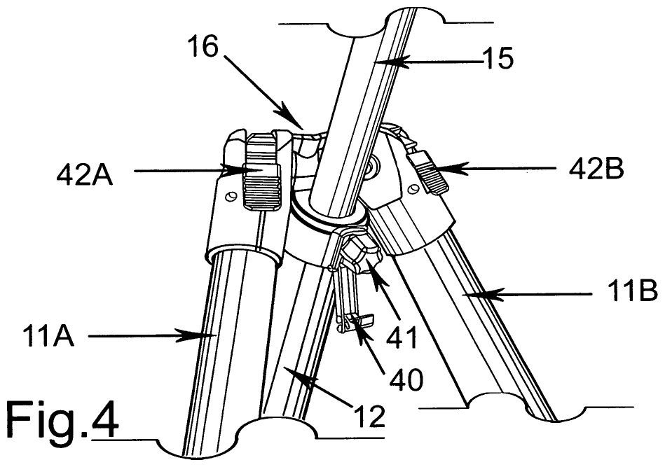

FIG. 4 illustrates the positions of the legs together with the extension member.

Center member 16 has two receivers 42A and 42B which are securable to legs 11A and 11B respectively. The center hollow leg 12 is recured to center member 16 via an opening with locking nut 41 which secure extension 15 at the desired length.

Foldable hook is used to fasten a backpack or other hanging accessory to platform 16, thereby providing both easy access to the backpack and an anchoring weight.

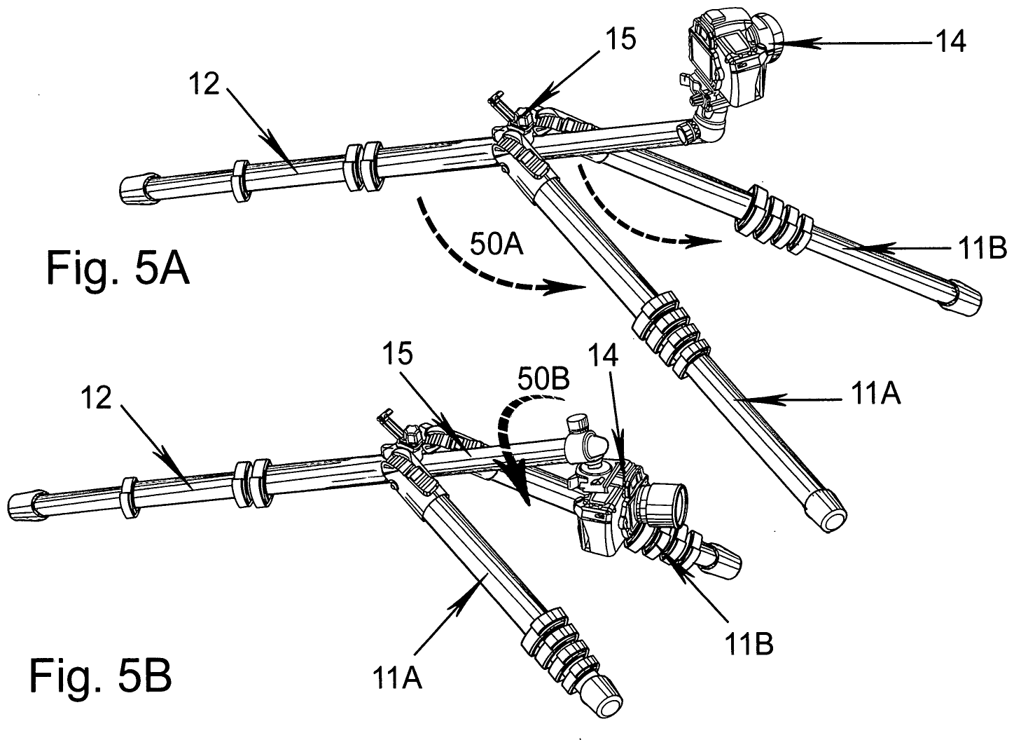

FIGS. 5A and 5B illustrates the tripod positioned for a close to ground shot.

The present invention allows the switch from upright (as shown in FIGS. 2A and 2B) to close to the ground shots very quickly and without need to disassemble the tripod.

Without the need to remove the center hollow leg of the present invention, there isn't a need for the center column to be removed or reconfigured. One simply has to angle the two side legs 11A and 11B at a more spread angle arrangement (as indicated by arrow 50A). This lowers the tripod allowing camera 14 to be positioned for a close to earth show as shown in FIG. 5A.

As shown in FIG. 5B, by rotating extension 15 to “flip” the camera 14 upside down, an extremely close picture can be obtained, all without having to disassembly the tripod as required in the prior art. This arrangement provides a faster and more convenient way when switching between upright and low-to-ground shots.

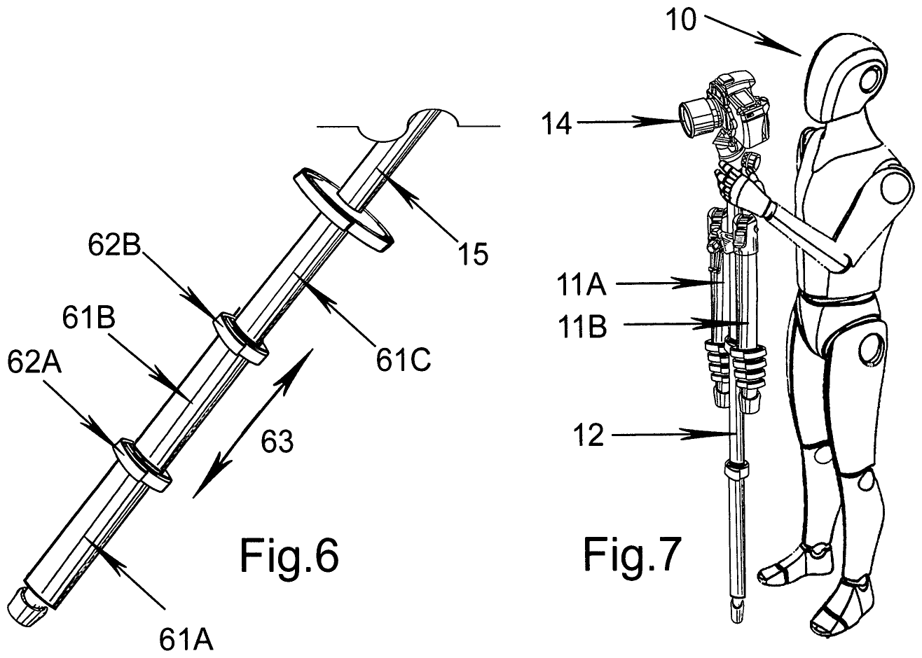

FIG. 6 illustrates an embodiment of the center hollow leg that maintains the hollow nature when collapsed.

In this embodiment, the hollow center leg 12, is “opposite” of a traditional leg in that the bottom section 61A is wider than the section above it 61B, allowing the bottom section 61A to “slide”, as illustrated by arrow 63, over the upper section 61B, which is also allowed to slide over the next section 61C. Each leg section is secured via locking nuts such as 62A and 62B.

This arrangement frees up the center of the hollow center leg 12 during transportation so that the extension 15 may remain contained within the leg.

FIG. 7 illustrates the tripod of this invention being used as monopod.

The tripod of the present invention can also be used as a monopod. To accomplish this, legs 11A and 11B are collapsed and the hollow center leg 12 is kept at its lengthened state. This allows operator 10 to stand with the tripod, now a monopod, and utilize camera 14.

This capability is facilitated by the extension and the hollow center leg being linear in relationship to each other, providing for a perfect centering which would not be available for a traditional tripod. In this invention the weight of the camera is centered directly over the leg.

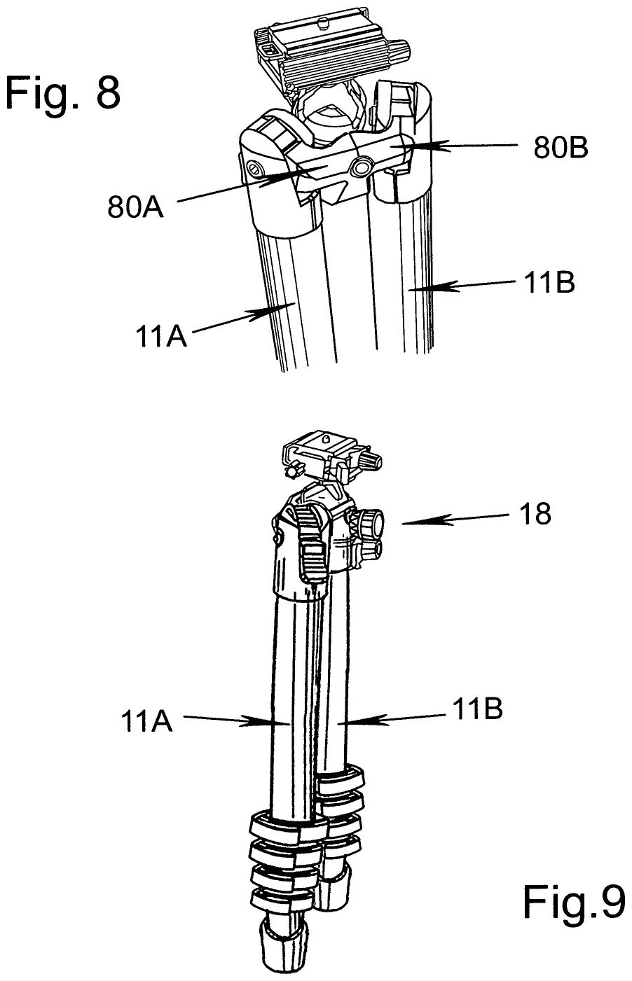

FIG. 8 illustrates the legs and center member of the preferred embodiment.

In this illustration, the hinging members 80A and 80B are configured to allow maximum freedom of movement while maintaining stability. Hinge 80A is secured to leg 11A and hinge 80B is secured to leg 11B.

FIG. 9 illustrates the tripod collapsed for transportation.

Once collapsed, the legs 11A and 11B, are closer to the hollow center leg (not visible in this angle) and fold up compactly allowing for easy transportation. Note that the extension does not have to be removed and merely is contained within the hollow center leg. This compact result is due to the invention placement of the legs being substantially in line with each other.

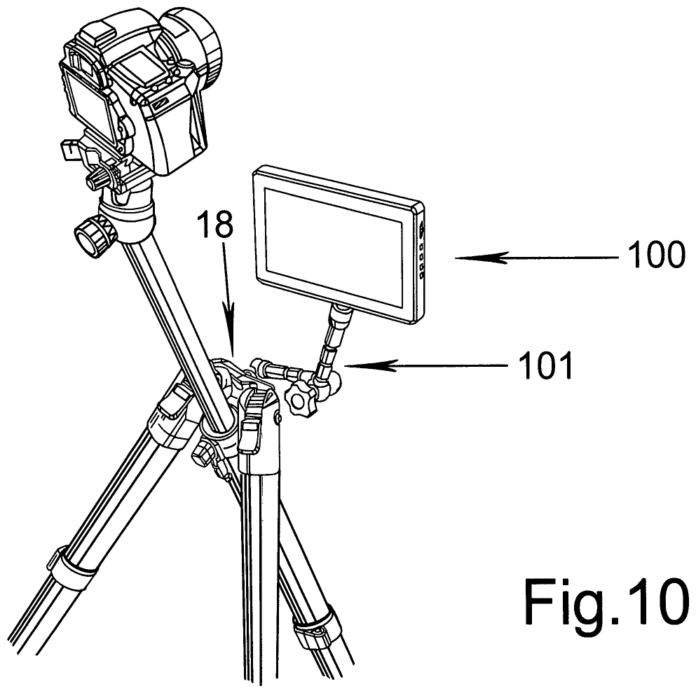

FIG. 10 illustrates the deployment of a screen from the platform.

Armature 101 extends from center member 18 and holds screen 100 so that the user is able to monitor screen 100. This arrangement, allows screen 100 to display what is being viewed by the camera and is particularly useful for situations where the camera is extended well above the operator's head and line of sight.

It is clear that the present invention is more ergonomical and its use is greatly enhanced (e.g. setup speed, user position when operating camera). The tripod is more stable and can fold into a smaller package.

It is clear that the present invention creates a highly improved portable tripod.

What is claimed is:

1. A tripod comprising:
a) a first side leg and a second side leg;
b) a center member having a first swivel and a second swivel, the first side leg being connected at a first end thereof to the first swivel, the second side leg being connected at a first end thereof to the second swivel, said center member further having a circular receiver positioned between the first swivel and the second swivel;
c) a hollow center leg connected at a first end thereof to the circular receiver at a non-vertical angle;
d) an elongated extension member partially contained within the hollow center leg and being extendable from the hollow center leg through the circular receiver of the center member; and,
e) an attachment mechanism secured to a distal end of the elongated extension member.

2. The tripod according to claim 1, wherein the first side leg and the second slide leg are extendable in length, and the hollow center leg is extendable in length.

3. The tripod according to claim 2,
a) wherein the center member includes a hook; and,
b) further including an accessory bag securable to the hook.

4. The tripod according to claim 3, wherein the attachment mechanism selectively rotates.

5. The tripod according to claim 3, wherein first swivel allows the first side leg to be folded against the hollow center leg; and the second swivel allows the second side leg to be folded against the hollow center leg.

6. The tripod according to claim 5, further including an articulated mount secured to the center member, said articulated mount adapted to receive a viewing screen.

7. A tripod comprising:
a) a center member having a first swivel and a second swivel and a circular receiver positioned between the first swivel and the second swivel;
b) a first extendable side leg having a first end thereof connected to the first swivel;
c) a second extendable side leg having a first end thereof connected to the second swivel; and,
d) a hollow extendable center leg having a first end connected to the circular receiver not in vertical alignment.

8. The tripod according to claim 7, wherein first swivel allows the first side leg to be folded against the hollow center leg; and the second swivel allows the second side leg to be folded against the hollow center leg.

9. The tripod according to claim 7, further including an elongated extension member partially contained within the hollow center leg and being extendable from the hollow center leg through the circular receiver of the center member.

10. The tripod according to claim 9, further including a rotatable attachment mechanism secured to a distal end of the elongated extension member.

11. The tripod according to claim 10, further including an articulated mount secured to the center member, said articulated mount adapted to receive a viewing screen.

12. The tripod according to claim 7,
a) wherein the center member includes a hook; and,
b) further including an accessory bag securable to the hook.

13. A tripod comprising:
a) a center member having a first swivel and a second swivel and a circular receiver positioned between the first swivel and the second swivel such that the circular receiver is not vertically aligned, said receiver being moveable in a single plane;
b) a first extendable side leg having a first end connected to the first swivel;
c) a second extendable side leg having a first end connected to the second swivel; and,
d) a hollow extendable center leg having a first end connected to the circular receiver.

14. The tripod according to claim 13, wherein the first swivel moves in three dimensions, and the second swivel moves in three dimensions.

15. The tripod according to claim 14, wherein the first swivel is configured to allow the first side leg to be moved against the hollow center leg; and the second swivel is configured to allow the second side leg to be moved against the hollow center leg.

16. The tripod according to claim 14, further including an elongated extension member partially contained within the hollow center leg and being extendable from the hollow center leg through the circular receiver of the center member.

17. The tripod according to claim 16, further including:
a) an attachment mechanism secured to a distal end of the elongated extension member; and,
b) an articulated mount secured to the center member, said articulated mount adapted to receive a viewing screen.

18. The tripod according to claim 17,
a) wherein the center member includes a hook; and,
b) further including an accessory bag securable to the hook.
